(19) United States
(12) Patent Application Publication
(10) Pub. No.: US 2005/0278249 A1
(43) Pub. Date: Dec. 15, 2005

(54) Business management system, method and tool

(75) Inventors: Rodney R. Jones, Brush Prairie, WA (US); Kenneth T. Shand, Beaverton, OR (US)

Correspondence Address: IDEA ADVOCATES LAW GROUP LLC, 239 NW 13TH AVE., SUITE 310, PORTLAND, OR, 97209, US

(73) Assignee: Northwest Auto Finance Corp.

(21) Appl. No.: 11/154,417

(22) Filed: Jun. 15, 2005

Related U.S. Application Data
(60) Provisional application No. 60/580,283, filed on Jun. 15, 2004.

(51) Int. Cl. G06F 17/60

(52) U.S. Cl. 705/38

(57) ABSTRACT

The invented world-wide web-based financed-sale management method includes providing a computer with world-wide web access to databases including plural-customer credit ratings, plural-lender guidelines and user risk management guideline data; obtaining loan application data from a live customer; entering the loan application data into the computer over the world-wide web; and determining at the computer a best-fit lender based on accessed live customer credit rating data, plural-lender guidelines and risk management guideline data. The invented loan decision-facilitating computer software tool includes an iconographic display window associated with a computer, the window displaying a set of plural loan parameters, at least one of the parameters within the window being adjustable by user input; a first computer software mechanism responsive to user input on the at least one parameter, the mechanism calculating any changes to other of the plural loan parameters and updating the display window to reflect such any changes; a second computer software mechanism for analyzing the plural loan parameters within the display window and assigning a merit level to the loan represented by the plural loan parameters based upon defined merit criteria stored in the computer; and a graphic gauge in the display window coupled with the second computer software mechanism for indicating to the user the assigned merit level.

### RELATED APPLICATIONS

The present application claims priority to U.S. Provisional Patent Application Ser. No. 60/580,283, entitled VEHICLE SALES SYSTEM AND METHOD and filed Jun. 15, 2004, the disclosure of which is incorporated herein in its entirety by this reference.

### BACKGROUND OF THE INVENTION

This invention relates generally to the field of business management tools. More particularly, it concerns retail, insurance or annuity sales management decision-making tools.

Conventional sales management decision-making is very time consuming and fraught with uncertainty. Of course, consumers with perfect credit can obtain more credit without much time or effort, since their loan applications are approved immediately. But for consumers with middle- to low-tier credit ratings (e.g. under approximately 600 points), obtaining loan approval can be time-consuming and frustrating. Such middle- to low-tier credit rating loans and loan applications will be referred to herein as “non-prime.”

FIG. 1 illustrates a conventional auto loan-processing timeline from submission of an application by an auto dealer to receipt of a check from a lender that involves a minimum of three days and a maximum of twenty-one days or more. As noted, the time line assumes the application is submitted during normal business hours. If submitted after 5 PM or on weekends (not atypical), the process can take an additional twelve to forty-eight hours.

Referring to FIG. 1, a dealer submits a consumer's application via fax or DealerTrack™-like (on-line loan application submission) software at 100. A fax is received by a lender at 102 and a loan clerk or analyst enters the loan application data manually at 104, which process takes twenty minutes to two hours. Alternatively, the semi-automated, digital data-based DealerTrack™ process 108 takes five to ten minutes. At 106, a loan clerk or analyst at the lending institution pulls the consumer's credit information (typically from a loan origination system (LOS) and manually or semi-automatically generates a proprietary screening process to generate a consumer scorecard. At 110, the analyst reviews the application, credit history and scorecard. If the customer's loan application is declined at 112, loan processing ends. The review process consumes between five minutes and three hours.

If approved at 114, then at 116 the analyst follows up by phone with the dealership or, if available, a field representative follows up with the dealership's salesperson or sales manager in person. At 118, negotiations might ensue between the analyst and the dealer. The dealer might discuss alternative rates, terms and conditions including the dollar amount advanced with alternative lenders. There is a very real possibility that at 120 the deal might be lost to the competition, that the consumer will walk down the road to another auto dealer. This could occur because, although the credit was approved, it was approved by a non-prime lender at a too-high interest rate. Another prospective lender might offer a better deal, e.g. it might be more willing to work with the customer on annual percentage rate (APR), term or down payment amount. This follow-up and negotiation process can take as little as ten minutes and as much as twenty-four hours.

At 122, any required contract rewrite (pursuant to negotiations between dealer and lender) is done, which re-write can take from one to five days. If not re-write is required, then the deal is captured at 124 and sent to the finance office at 126, which conveyance can take an additional one to three days. The deal is conveyed to the Dealer Business Office at 128, which process can take yet another one to three days. The deal is mailed or couriered at 130 to the Financial Institution Funding Center, which conveyance can take still another one to three days. At 132, the Financial Institution Funding Center verifies the documents, collateral, customer, insurance, lien holder information on the application for title to the vehicle, and notes any discrepancies. This process can take yet another one to four days.

Finally, at 134, the loan is funded. Nevertheless, an automated clearing house (ACH) at 136 can take another one to two days to clear the funding electronically. Alternatively, by manual means a check at 138 can issue, which checking process also can take one to three days.

All in all, loan processing by conventional means—even if started during normal business hours and even if accelerated by a few minutes via an on-line, digital conveyance of the loan application data via a DealerTrack™-like conveyance—in the very best case takes more than six days. And in the worse case, despite such on-line data conveyance, loan processing by conventional means takes more than twenty-two days.

### SUMMARY OF THE INVENTION

The invention moves loan decision-making from the traditional back office of a lending institution to the front office of a retailer where the consumer is waiting for approval of an installment purchase. In the context of the auto retailer, loan decision-making is rendered portable so that a field-based, mobile loan specialist can assist his or her customer, i.e. an auto dealer, in closing an auto purchase deal with the auto dealer's customer, the buyer (referred to herein as the consumer). The invention is useful in a wide variety of loan decision-making and business management applications, and thus is not limited to auto dealerships. For example, it is useful in the fields of real estate mortgages, insurance and annuities, all of which are typically purchased over time.

The invented world-wide web-based financed-sale management method includes providing a computer with world-wide web access to databases including plural-customer credit ratings, plural-lender guidelines and user risk management guideline data; obtaining loan application data from a live customer; entering the loan application data into the computer over the world-wide web; and determining at the computer a best-fit lender based on accessed live customer credit rating data, plural-lender guidelines and risk management guideline data. The invented real-time computer-assisted loan decision-making method includes obtaining loan application data from a proximate customer; retrieving real-time loan-approval criteria via a remote data source from plural lenders or underwriters; processing the loan application data on a computer using the retrieved criteria to produce comparative data regarding loan qualifications of the proximate customer relative to the plural lenders or underwriters; and presenting the comparative data on a proximate display in graphical or tabular form. The invented loan decision-facilitating computer software tool includes an iconographic display window associated with a computer, the window displaying a set of plural loan parameters, at least one of the parameters within the window being adjustable by user input; a first computer software mechanism responsive to user input on the at least one parameter, the mechanism calculating any changes to other of the plural loan parameters and updating the display window to reflect such any changes; a second computer software mechanism for analyzing the plural loan parameters within the display window and assigning a merit level to the loan represented by the plural loan parameters based upon defined merit criteria stored in the computer; and a graphic gauge in the display window coupled with the second computer software mechanism for indicating to the user the assigned merit level.

Sequoia™, Sequoia Acceptance™ and Dashboard™ are all trademarks and/or service marks owned by Sequoia Acceptance Corporation, an assumed business name of Northwest Auto Finance Corporation, a Washington-based corporation and the assignee of the present invention. All rights are reserved, world-wide.

### BRIEF DESCRIPTION OF THE DRAWINGS

FIG. 1 is a schematic diagram illustrating a conventional auto loan processing timeline.

FIG. 2. is a simplified schematic overview of the Dashboard™ decisional process, in accordance with one embodiment of the invention.

FIG. 3. is a schematic system block diagram of the invented system, in accordance with one embodiment of the invention.

FIG. 4 is a schematic block diagram illustrating the data sourcing aspects of the invention, in accordance with one embodiment of the invention.

FIG. 5 is a simplified schematic diagram illustrating the three-tiered architecture of the Dashboard™ system and part of the graphic user interface (GUI) that forms a part thereof, in accordance with one embodiment of the invention.

FIGS. 6-11 are screen grabs illustrating other parts of the graphic user interface (GUI) that forms a part of the Dashboard™ system, in accordance with one embodiment of the invention. Specifically, FIG. 6 represents a Territory Management Report screen, FIG. 7 represents a Cash Flow and Loan Profit Calculator screen, FIG. 8 represents an Origination Income Calculator, FIG. 9 represents a Loan Origination Rules Engine screen, FIG. 10 represents a Risk and Yield Analysis screen and FIG. 11 represents a Lending Partner Filters screen.

FIG. 12 is a schematic block diagram illustrating the architecture of the invented system, in accordance with one embodiment of the invention.

FIG. 13 is a flowchart illustrating the loan decision-making method in accordance with one embodiment of the invention.

FIG. 14 is a schematic illustration of the loan decision-making flow timeline in accordance with one embodiment of the invention.

FIG. 15 is a schematic illustration of a typical auto loan processing flow timeline in accordance with one embodiment of the invention.

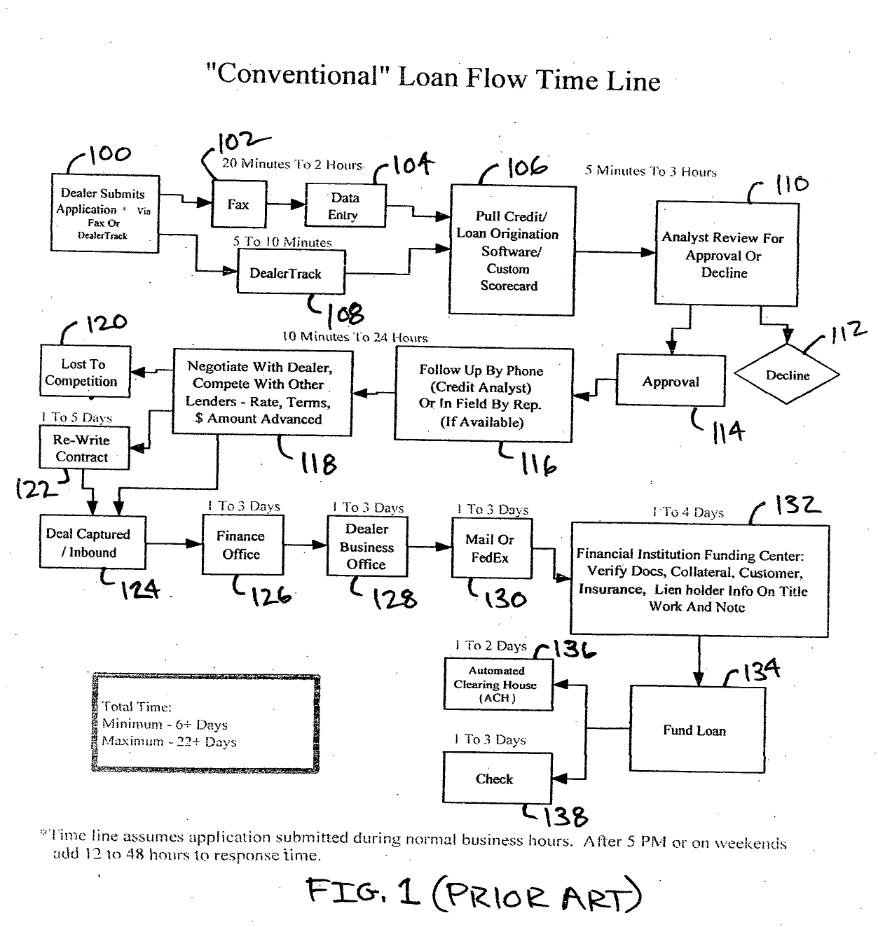

### DETAILED DESCRIPTION OF THE PREFERRED EMBODIMENTS

Lender, as used herein, refers to an authorized User of the invented system, method and tool. Senior Loan Specialist (SLS), as used herein, refers to an experienced employee or agent of the Lender who visits Dealers or Dealerships to make loan decisions. Dealer or Dealership or other Retailer that is a Customer of the Lender and that is visited by the SLS to make decisions on behalf of the Lender and/or the Lender's Lending Partners. Lending Partners, as used herein, refers to affiliated lending institutions that are chosen by the Lender as alternative lenders in cases when the Lender declines to hold a loan contract but instead brokers it for a fee to one of the Lending Partners. Customer, as used herein, generally refers to the Lender's Customer, or the Dealer or Dealership or Retailer. Consumer, as used herein, refers to the Dealer's or Dealership's or Retailer's Customer, e.g. the prospective purchaser of goods or services. The terms are illustrative, especially in the auto dealership context in which the invention is described and illustrated, and are not intended to limit the invention in any way.

The Sequoia™ Dashboard™ back-office-in-a-box software system includes plural, integrated, web-based software tools that simplify and expedite the loan application, decision-making, fulfillment and papering processes for making retail purchases, e.g. buying an automobile on time from an auto dealership, buying a home on time from a seller, buying insurance, paying into an annuity or other investment on time from an insurer or broker, etc. It allows the purchase by lenders of the most profitable loans while at the same time minimizing the risk of loss to the lender. The Dashboard™ software aggregates many of the back-office functions relating to the loan decision-making process into a web-based, desktop or portable computer-accessible software system and displays the information in concise, graphical form in order for the Senior Loan Specialist (SLS) in the field and in real time to make the right decision, and, if authorized, to purchase the loan on behalf of a lender, thus rendering the entire process ‘portable.’ The SLS can process a loan anytime, anywhere with total mobility. Thus, the invention is referred to herein as a back-office-in-a-box business management tool kit.

The invention relocates the decision-making capability from a remote institutional back office to the storefront where the consumer is located and where the purchase transaction is pending. Evenings and weekends notwithstanding, the invention reduces the conventional non-prime auto loan processing timeline from submission of an application to receipt of a lender's check by the auto dealership to a mere thirty minutes in the best case to a mere two hours in the worst. By simple virtue of the reduced time, risk and uncertainty are commensurately reduced. The intelligent data gathering, processing and presentation features provide checks and balances in the invented system so that risk and uncertainty are further diminished. Efficiency and profitability are maximized.

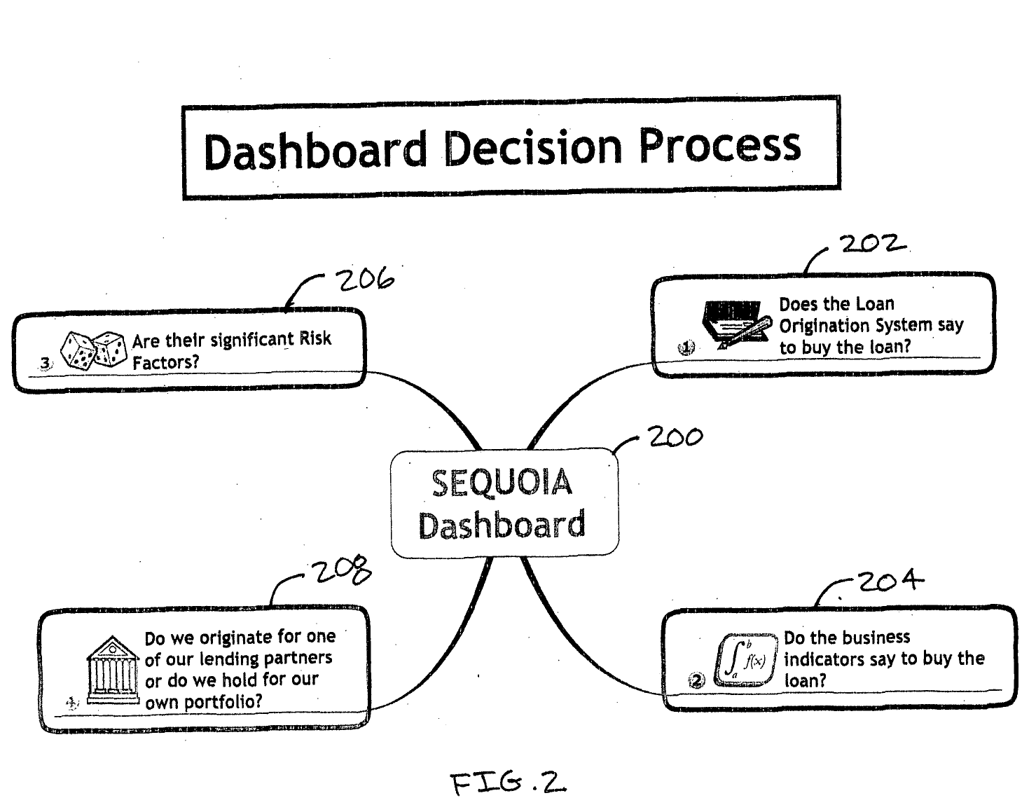

FIG. 2 is a schematic overview of the Dashboard™ decision-making process. Very simply, the Sequoia™ Dashboard™ software (block 200) makes decisions for the user of the invention by asking and facilitating answers to four questions:
1) Does the Loan Origination System (LOS) say to buy the loan (block 202)?
2) Do the business indicators say to buy the loan (block 204)?
3) Are there Significant Risk Factors (SRFs) (block 206)?
4) Should the company originate for one of its lending partners or should it hold the loan for its own loan portfolio (block 208)?

Those of skill in the art will appreciate that FIG. 2 is a conceptual model of the decision-making model relied on by the invention, and that the mechanics of such decision-making in accordance with a preferred embodiment of the invention will be described in detail below. Those of skill in the art also will appreciate that, within the spirit and scope of the invention, these and other questions may be asked and answered to make lending decisions for a licensed user of the invention, e.g. the company, or the user's lending partners.

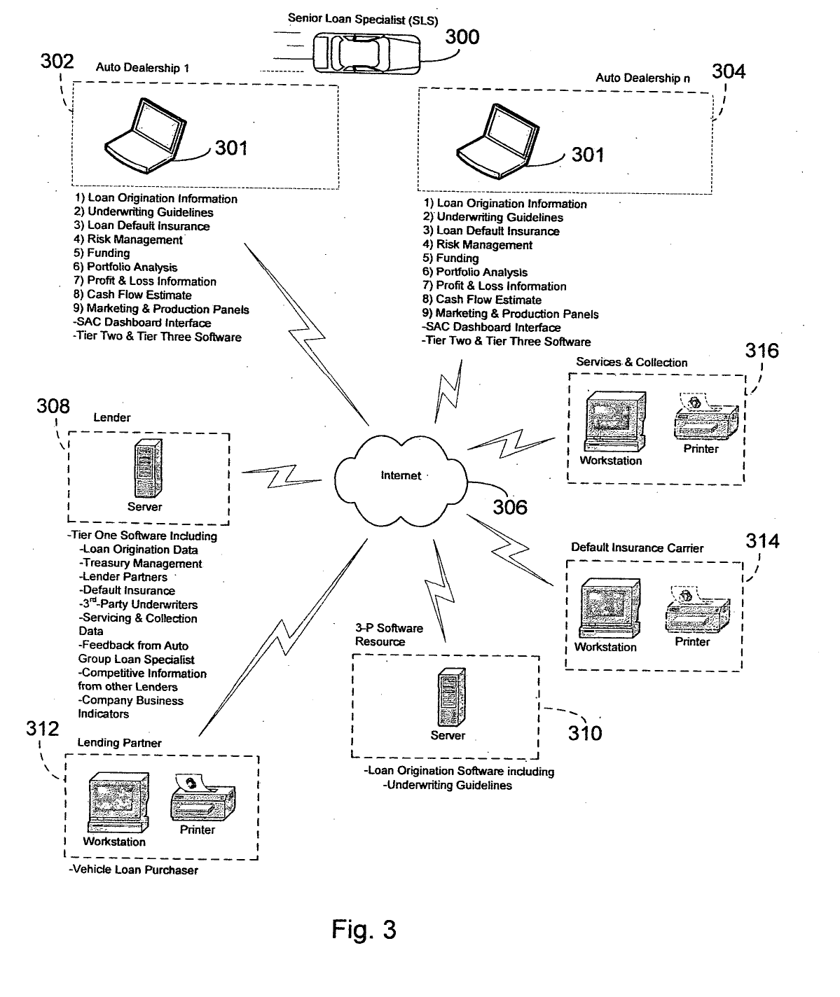

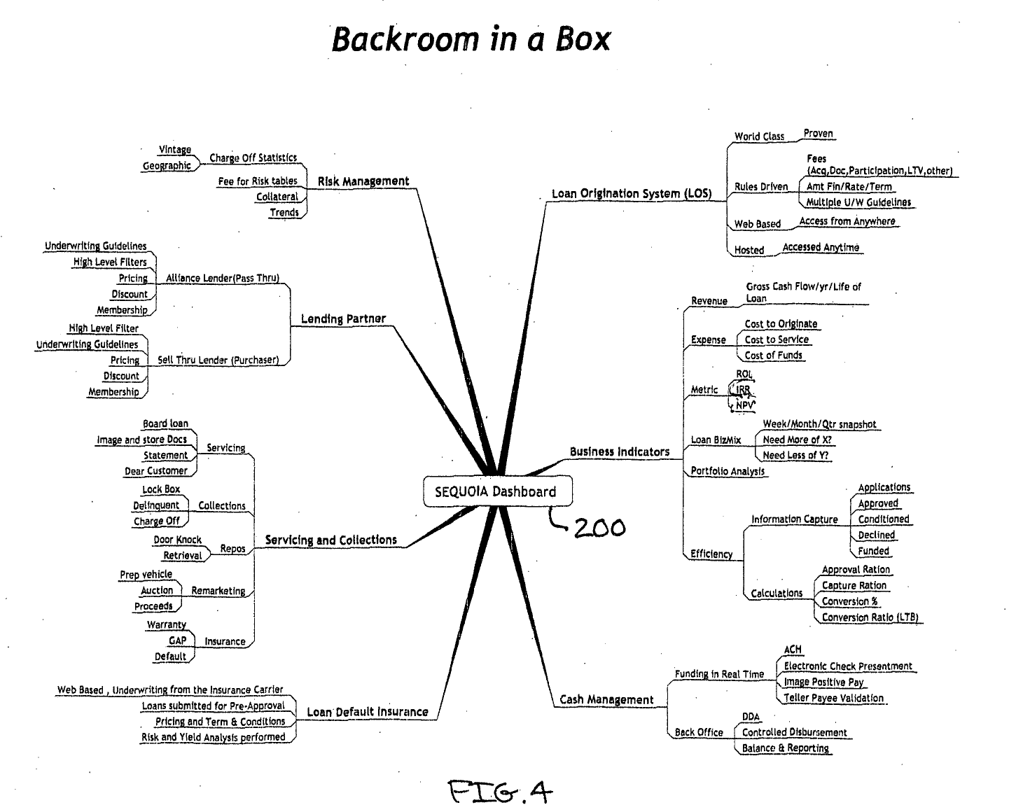

FIG. 3 illustrates how the Dashboard™ system works in the form of a simplified system block diagram form. The Senior Loan Specialist (SLS) 300 equipped with a laptop computer 301 (or equivalent portable web access device) is mobile (as indicated by the vehicle iconography) and travels between n User-affiliated (e.g. Lender-affiliated) auto dealerships including Auto Dealership 1 (block 302) and Auto Dealership n (block 304). It will be understood that SLS 300 with his or her laptop computer 301 has access at any of the n Auto Dealerships via the invented system, method and tool to all of the capabilities listed below the Dealership 1-n blocks. This is because his laptop computer is portable and provides wireless web access to all of the other components of the web-based system when SLS 300 is visiting the Auto Dealerships 1-n. This is why laptop computer 301 is shown within each of the Auto Dealership 1-n blocks. Those of skill in the art will appreciate that there need be only one portable laptop computer 301 for each SLA 300.

Loan terms are negotiated and approved using the Dashboard™ system software, which may be installed on or downloaded to laptop computer 301, or which may be accessed using laptop computer 301, on-line, via the Internet 306, as illustrated. (Those of skill in the art will appreciate that, instead of laptop computer 301, the portable device used by SLS 300 can be a personal digital assistant (PDA) or mobile phone preferably equipped for wireless web access.) The Lender (block 308) that typically employs the SLS may assist and oversight and buy the loan contracts as deals are closed by SLS 300 at the various dealerships via a corporate Server that is connected to the SLS's laptop computer 301 via the Internet 306.

Third-party (3-P) loan origination software (LOS—block 310) that includes Underwriting Guidelines is accessed via the Internet 306 and provides credit, interest rate and other information to the loan specialist during the deal-making. Loan contract purchases may be made by Lender 308 or may be brokered for an acquisition fee to one of the Lender's Lending Partners (block 312) within or in close affiliation with the Lender 308 or even to a third-party (3-P) purchaser unaffiliated with Lender 308. A vertically integrated or 3-P Default Insurance Carrier (block 314) with a Printer-equipped Workstation can be accessed also over the Internet 306 to reduce risk. Similarly, an integrated or 3-P Services & Collection (block 316) with a Printer-equipped Workstation can be accessed over the Internet 306 to further automate and risk-manage loan servicing and default-avoidance. Car sale deals are made more quickly and with less hassle; transactions are secured via the Internet; loan contracts are quickly purchased. Customer purchases are more quickly fulfilled and sales commissions are more quickly realized. Particulars of the Dashboard™ system including first, second and third tier software are as described and illustrated elsewhere herein.

Thus, the Sequoia™ Dashboard™ system consolidates several traditional job functions: Credit Analyst, Credit Buyer, Business Analyst and Marketing into a single, integrated portable tool or tool suite that helps the SLS to make faster and more intelligent decisions on which auto loan contracts to buy for the Lender or broker to a Lending Partner. This tool allows the purchase of loans at the decision-making point, i.e. in the auto dealership instead of in the back office where traditional financing decisions are made. Making the decision at the dealership allows the SLS to evaluate key factors in real time. Such key factors include revenue and profit to the Lender as well as risk and loss to the Lender. Those of skill in the art will appreciate that the invented system is applicable to other financial decision making other than vehicle sales, including real estate mortgage financing, insurance financing, annuity or other investment purchases, etc., all of which involve decision-making and approval of a customer's or client's ability to make extended timely payments. Such alternative applications are contemplated as being within the spirit and scope of the invention.

The Sequoia™ Dashboard™ system moves the processing of the loan from the backroom to the purchase transaction site, e.g. the auto dealership, where the consumer is located. The SLS, working on a personal or laptop computer, personal digital assistant (PDA), or cell phone, for example, is able to do all the loan processing and company business analysis onsite at the dealership and to initiate funding of the loan to the dealer. The invented software tool suite consolidates multiple decision-making features in the loan-evaluation process. The invention allows for two-way communication between the company and its strategic partners. Real-time decisions can be made about auto loans the licensed user of the invented system might keep for its own loan portfolio or originate a loan for a lending partner. Key data that feed into the Dashboard™ decision-making software include:
1) The Lender's revenues and profit goals as well as other business metrics downloaded to the Dashboard™ system. This allows the SLS clearly and quickly to decide how the loan purchase affects the Lender's financial position. Does the loan generate enough cash flow for the Lender's business goals? If not, at what combination of interest rate and/or acquisition fee does it make sense to extend the loan? These adjustments can be communicated to the auto dealer or retailer.
2) The Loan Origination System (LOS), a web-based system loaded with Lender underwriting guidelines, makes decisions on which loans to purchase. It pulls customer credit and applies criteria based on established credit rules. The results are delivered to the Dashboard™ system. The LOS determines the customer's proper debt-to-income and payment-to-income ratios by calculating these from the customer's credit file. Many similar calculations are made to enable the SLS to analyze the prospective loan. The Dashboard™ system also tracks the customer, e.g. auto dealer, loan from the initial application, to verification, to funding and then on to loan servicing.
3) Risk management and loss mitigation factors from a loan history database and from 3-P underwriter databases are downloaded to the Dashboard™ system. For example, certain vehicles maintain their value longer than others and this is factored into the loan decision process.
4) Lending partners' loan filters and underwriting guidelines are incorporated into the Dashboard™ system to provide the flexibility of capturing a loan either for a Lender's portfolio or for a Lending Partner's portfolio, with an acquisition fee being paid to the Lender who brokers such a deal for a Lending Partner. This allows the Lender to maximize every loan yield and also to be a full spectrum lender to the auto dealer. If the loan is not a good fit for the company's loan portfolio but it is possible to obtain an origination or acquisition fee from a Lending Partner by delivering the loan contract to the a Lending Partner, then loan origination data can be sent electronically to the prospective Lending Partner to enable the Lending Partner to capture the loan.
5) Loan default insurance can be offered to Lending Partners that desire this option. Loan default insurance can be added to higher risk loans to make them more attractive to certain Lending Partners. The Dashboard™ system interfaces to an Insurance Carrier's default insurance underwriting system and returns the insurance decisions in real time. Default insurance allows a Lender or one of its Lending Partners to capture a loan that otherwise might have been let go.

The invention saves significant time and greatly reduces risk. It saves time not only for retail customers (consumers) or clients, salespersons and sales managers but also for loan specialists, underwriters, managers and brokers. It does so by automated field-level screening of applicants in accordance with the Lender's or Lending Partners' approval criteria and routing of loan applications for approval only to those Lending Partners whose criteria are met or nearly so. Thus the Lender or Lending Partner receives and reviews higher quality loan applications, in terms of the likelihood of approval. And the decision is made in nearly real-time response to a retail customer's or client's preferences and abilities.

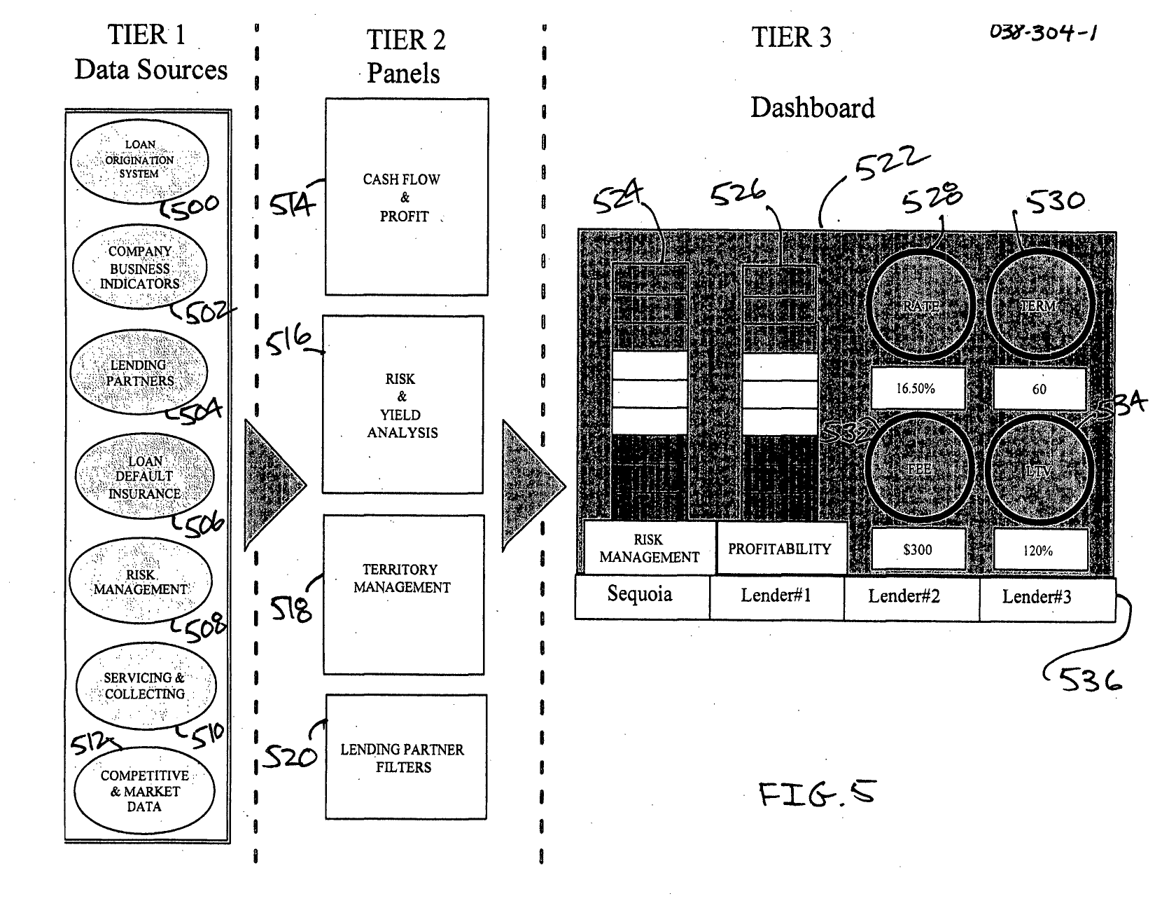

FIG. 4 is labeled Backroom in a Box, and represents a schematic representation of the wide variety of data input categories and specifics that are comprehended by the invention. The data input paths of FIG. 4 are arranged like spokes of a wheel, with each spoke representing a different source or category of data input to the core data gathering, processing and presentation aspects of the Sequoia™ Dashboard™ software system 200. The inputs will be described generally in the order they appear clockwise, starting with Loan Origination System (LOS). The various major categories of data inputs to Sequoia™ Dashboard™ software system 200 are labeled in boldface, and their respective data inputs are represented as hierarchical data ‘branches’ of each categorical data ‘tree’.

Loan Origination System (LOS) data are ubiquitous and world class, and thus proven, ways of processing loans. LOS data are rules-driven and take into consideration fees (e.g. acquisition, documentation, participation, loan to value (LTV, i.e. the amount of an auto loan relative to the auto's value—the higher the LTV, the higher the lender's risk) and other); amount financed, rate and term; and multiple underwriting (U/W) guidelines. LOS data are web-based, providing access from anywhere. Finally, LOS data are hosted by LOS providers, and can be accessed 24/7/365. Those of skill in the art will appreciate that other data can be gathered and provided to the Sequoia™ Dashboard™ software system 200 from the LOS data input category.

Furthermore, as can be seen from FIG. 4, in accordance with the invented system, LOS data are but one of many data inputs to the decisional software. The additional data inputs are described below.

Business Indicators data include Revenue (e.g. gross cash flow/yr/life of loan); Expense (e.g. cost to originate, service and fund); Metric (e.g. Return on Investment (ROI), internal rate of return (IRR, i.e. the internal cost of capital that an investment must make to be sensible) and net present value (NPV, i.e. dollar value today v. dollar value projected in the future taking account of inflation, capital cost, etc. When a SLS computes the value of a prospective loan purchase, he or she needs to know how profitable the loan will be. The invention allows an SLS to calculate the future cash-flow of the prospective loan using NPV data)); Loan ‘BizMix’ (e.g. week/month/quarter snapshots of the mix of portfolio loans over the range of loan tiers—need more of X? and need less of Y?); Portfolio Analysis; and Efficiency (e.g. information capture and calculations data). Information capture data can include the number of applications received, approved, conditioned, declined and funded. Calculations can include approval ratio, capture ratio, conversion percentage (%) and conversion ratio, i.e. look to book (LTB, i.e. the number of applications a lender looks at v. the number actually funded).

Typical large lenders have LTBs of only 5-8%; users of the invention will realize LTBs of 30-40% or higher, a surprising improvement of nearly an order of magnitude. Those of skill in the art will appreciate that other data can be gathered and provided to Sequoia™ Dashboard™ software system 200 from the Business Indicators data input category.

Cash management data include Funding in Real Time data (e.g. ACH, electronic check presentment, image positive pay and teller payee validation) and Back Office data (e.g. direct deposit account (DDA, i.e. a checking account), controlled disbursement and balance & reporting). Those of skill in the art will appreciate that other data can be gathered and provided to Sequoia™ Dashboard™ software system 200 from the Cash Management data input category.

Loan Default Insurance data include web-based underwriting data from the insurance carrier; loan data submitted for pre-approval; pricing and terms & conditions (T&Cs) data; and risk and yield analysis data. Those of skill in the art will appreciate that other data can be gathered and provided to Sequoia™ Dashboard™ software system 200 from the Loan Default Insurance data input category.

Servicing and Collections data include servicing data (e.g. board loan, image and store documents, statement and customer form letter); collections data (e.g. lock box, delinquent and charge-off); repossessions (“repos”) data (e.g. door knock, retrieval); remarketing data (e.g. prepare (“prep”) vehicle, auction and proceeds); and insurance data (e.g. warranty, GAP (i.e. insurance to shield a customer from loss due, for example, to casualty loss of a vehicle in a loan-purchase with an LTV over 100%) and default). Those of skill in the art will appreciate that other data can be gathered and provided to Sequoia™ Dashboard™ software system 200 from the Servicing and Collections data input category.

Lending Partner data include alliance lender (pass-through) data (e.g. underwriting guidelines, high-level filters, pricing, discount and membership) and sell through lender (purchaser) data (e.g. high-level filter, underwriting guidelines, pricing, discount and membership). Those of skill in the art will appreciate that other data can be gathered and provided to Sequoia™ Dashboard™ software system 200 from the Lending Partner data input category.

Risk Management data include charge-off statistics (e.g. vintage and geographic) data; fee for risk tables data; collateral data; and trends data. Those of skill in the art will appreciate that other data can be gathered and provided to Sequoia™ Dashboard™ software system 200 from the Risk Management data input category.

It may be seen from FIG. 4 that there is a volume of useful data sourced to and collected by the Sequoia™ Dashboard™ software system 200 in accordance with one embodiment of the invention. Conventionally, no more than two data categories—the LOS and perhaps Lending Partner underwriter guidelines, pricing, discount and membership data—have been gathered and processed in connection with retail sales and loan processing decision making.

Imagine a wheel with only two spokes, a very risky and unstable conveyance. In stark contrast, the invention provides the decision-making “wheel” with many data gathering “spokes”, thus stabilizing decision-making and greatly reducing the risk of unstable business operation or even failure.

With the invention, myriad other data can influence the prequalification or qualification of a consumer before the loan application is ever forwarded to a Lender or Lending Partner for approval or purchase. The financial impact on the Lender's cash flow can be assessed before a loan decision is made. The Lender's mix of business or a particular revenue or profit model can be accommodated before a sales or financing decision is made. “Dear Retail Customer” letters can be formulated automatically while the retail customer is still in the dealer's office. Default insurance can be priced and factored into a customer purchase model before the deal is consummated and the contract purchased by the Lender. Collateral risk and current trends in risk management can be given their due before the consumer drives the collateral away, thus making for more secure consumers and dealers, both of whom are effectively the Lender's customers.

By using the Dashboard™ software system, all this information is consolidated and displayed in an easy-to-view format that shows the positive and negative results of decision-making. Data such as interest rate, acquisition fees, etc. can be adjusted in real time and can be graphically displayed to show the immediate effects on the Lender's profit and loss (P&L) and risk-management position. Real-time adjustments are possible because all the information needed to purchase the loan is delivered to the SLS anytime, anywhere to give him or her total mobility. The ability to make quicker loan decisions shortens the cycle significantly for the auto dealership to receive its payment from the lender and gives the dealership added incentive to do business with the Lender or a Lending Partner affiliated with the Lender.

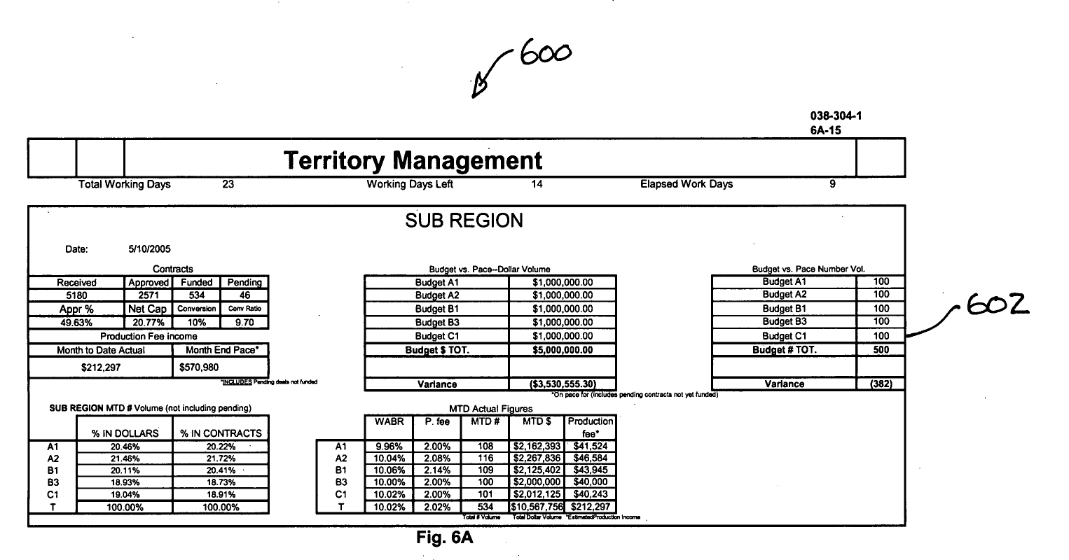

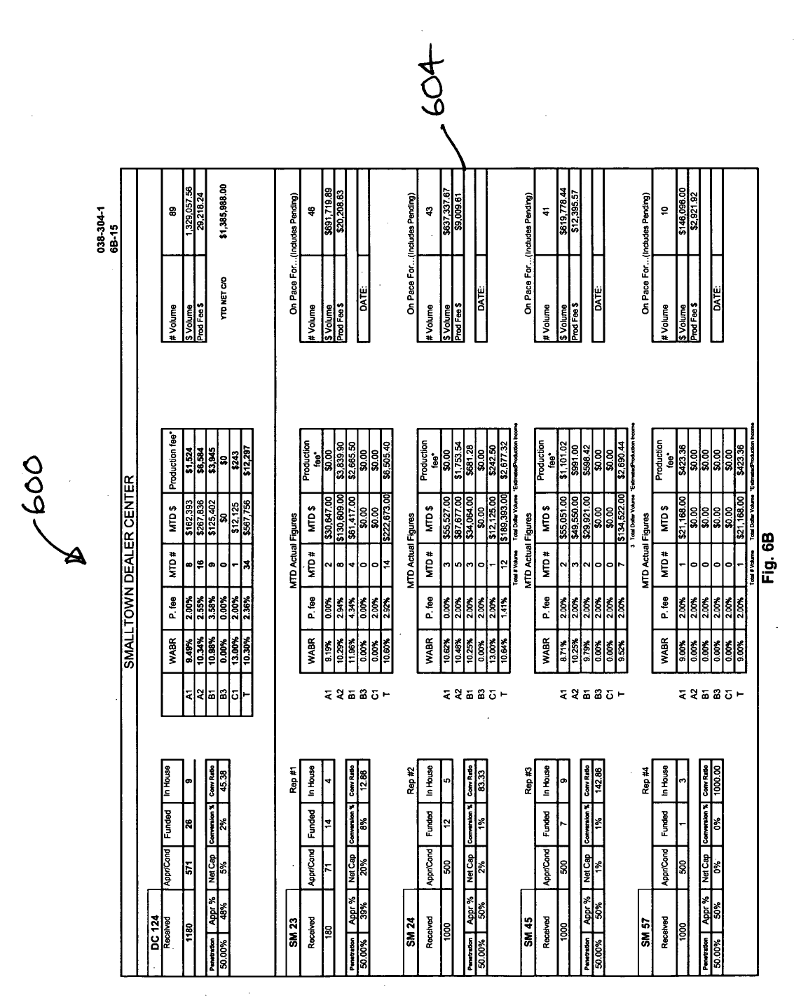

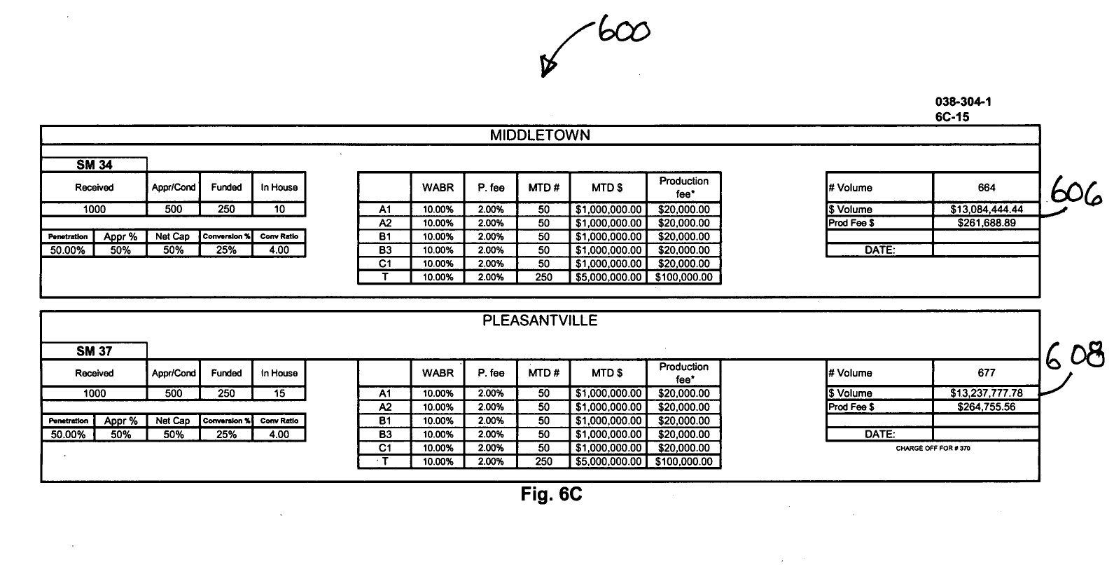

The Sequoia™ Dashboard™ system architecture and part of the graphical user interface (GUI) are shown in FIG. 5. The invention employs a three-tiered architecture. Tier 1 involves data sourcing from sources that include without limitation a Loan Origination System (LOS) data 500, a company business indicators data 502, lending partners data 504, loan default insurance data 506, risk management data 508, servicing and collection data 510 and competitive information from lenders data 512. Tier 2 involves data gathering/processing of the sourced data that includes without limitation a cash flow & profit panel 514, a risk and yield analysis panel 516, a territory management panel 518 and a lending partner filters panel 520. (Those of skill in the art will appreciate that other so-called ‘panels’ are contemplated as being within the spirit and scope of the invention, as will be seen by reference to FIGS. 6-11.) Tier 3 involves data presentation and manipulation of the various panels and particulars of a prospective deal within an iconographic work panel 522. Tier 1 will be understood from the discussion above by reference to FIG. 4. Tiers 2 and 3 will be discussed in detail below.

Tier 2 provides more sophisticated users of the invention with panels that assist in rendering loan decisions comprehensive not only of a customer's or client's ability, but comprehensive also of a Lender's business model, cash flow position, risk management position, profit goals and other short- and long-term factors. Sophisticated users might use cash flow & profit panel 514, for example, to analyze cash flow and profit data, origination income data and/or territory management data derived from LOS data 500, company business indicators data 502 and/or lending partners data 504. They might use risk & yield analysis panel 516, for example, to analyze the potential risk and yield of a prospective loan contract. They might use territory management panel 518, for example, to analyze how the Lender is performing month-to-date (MTD) or year-to-date (YTD) by territory or field representative (SLS). They might use lending partner filters panel 520, for example, to analyze the probability and income potential from brokering the loan contract to a Lending Partner in exchange for an acquisition fee payable to the Lender.

Those of skill in the art will appreciate that either raw data from the multiple data sources or processed data derived from such raw data from the multiple data sources are found within panels 514, 516, 518 and 520. Thus, Tier 2 represents a first level of data processing that collects and/or at least partly processes data from plural data sources that are useful in rendering Lender or other pertinent business decisions. Examples of these panels and the raw and at least partially processed data that they represent will be discussed below by reference to FIGS. 6 through 11. Sophisticated users customarily rely on such data to make such decisions, although conventionally such data has not been gathered together in one time and space and at least partially processed and presented in an integral form. Moreover, heretofore, such data were available only in the back rooms of institutional lenders located hundreds or thousands of miles from the site of the purchase transaction and the consumer. Those of skill in the art will appreciate that Tier 2 tools, i.e. panels, can be accessed in any suitable manner such as by simply pointing and clicking on an iconic button representing the desired panel.

At Tier 3, iconographic work panel 522 is a high-level tool that can be used by sophisticated or novice users of the invention to render loan and business management decisions. Tier 3 represents interactive software in accordance with the invention by which a user can quickly size up a prospective deal by viewing color-coded bar graphs and, optionally, by changing certain deal parameters. Risk management is represented in accordance with one embodiment of the invention by a color bar graph 524 the bottom three segments of which are red (high risk), the middle three segments of which are yellow (moderate risk) and the top three segments of which are green (low risk). Depending upon which segments of color bar graph 524 are highlighted by the software, the user can quickly assess high, moderate and low risk and respectively make a stop, caution or go decision. Profitability is represented similarly in a separate color-coded bar graph 526 preferably arranged side by side with color-coded risk management bar graph 524.

Those of skill in the art will appreciate that the icons within work panel 522 are formatted into the window using any suitable graphic build tools such as XML or HTML. The loan parameter windows are adjustable by user input, e.g. clicking to highlight and typing or editing. A software mechanism responsive to such adjustments re-calculates other affected parameters based on the adjustment and updates the parameter windows. The software mechanism also re-determines whether, from a risk management and profitability standpoint, the loan is a good or bad deal for the Lender, or somewhere in between. The risk management and profitability graphs are updated to reflect the adjustment. Thus, interaction between the user of what will be referred to herein as an interactive, iconographic loan decision-facilitating software tool provides instant re-evaluation and feedback to the user when one or more loan parameters is changed.

Risk and profitability straightforwardly can be evaluated by assigning weights to various risk and profitability factors and then mapping, e.g. via table look-up techniques, the level of risk or profit represented, e.g. by a weighted average, onto the graphs themselves to determine by computer which segment best represents the weighted average of the considered factors. Such a software mechanism is readily programmed by those of skill in the art by straightforward coding techniques.

Those of skill in the art also will appreciate that the user can click on any of the various lenders (whether Lender, e.g. Sequoia Acceptance™ or one of its Lending Partners) in the lender menu bar and the software mechanism automatically retrieves the chosen lender's guidelines and re-runs the current loan parameters through the new guidelines and updates the parameter windows, if needed, and the risk management and profitability graphs or loan merit gauges. If the dealership's own profitability guidelines change, such changes in real-time affect work panel 522 in terms of both the risk management and the profitability merit gauge. Instead of spending time filling in cells of complex spreadsheets, the user simply retypes or otherwise chooses a different parameter or lender and instantly the Dashboard™ system updates all affected parameters, re-evaluates the prospective deal and effectively makes a go/no-go recommendation to the user.

Accordingly, using work panel 522, a user can quickly assess both risk and profit potential for a given prospective deal. A Lender can establish guidelines, for example, that assist in rendering tough decisions when, for example, risk is high but profit also is also high or when, for example, risk is low but profit is also low, i.e. when the SLS in the field with his or her portable web access device having a color display simultaneously sees a green light and a red light. Other situations are easier—when the user sees two red lights the prospective deal is a bad one; when a user sees two green lights the deal is a good one. Of course, there are more than one decisional criterion (e.g. risk and profit) and there are degrees of good and bad in each, as represented in accordance with one embodiment of the invention by two side-by-side bar graphs, each including three differently colored regions or segments, each colored region having three sub-regions or sub-segments representing nine levels each of both risk and profit.

Work panel 522 in accordance with one embodiment of the invention also includes an array of parameter indicators including, for example, a rate indicator 528, a term indicator 530, a fee indicator 532 and an LTV indicator 534. By clicking the labeled button, the user can change one or more parameters and instantly affect the decision-making criteria, reflected instantly in the other indicators and in the decision-influencing risk and profitability bar graphs 524, 526. For example, if the user increases the fee (or down payment), the LTV will go down along with the risk, while profitability might be unaffected. The user thus can change one or more parameters and instantly assess the impact of the change on the decision-making process.

The user can choose a lender by pointing and clicking on a lender button within lender bar 536. The chosen lender's lending guidelines and risk factors and other criteria instantly come into play, and one or both of risk management bar graph 524 and profitability bar graph 526 changes to reflect the impact of such a choice. Work panel 522 can be understood to be a very easy-to-use and intuitive iconographic spreadsheet, rather than a conventionally esoteric cell-tabular spreadsheet that only a math student could work. Accordingly, the GUI of the invented Sequoia™ Dashboard™ system is extremely user-friendly.

In brief summary, the Sequoia™ Dashboard™ system comprises three major components that are orderly structured, or tiered. The first tier includes the data inputs and downloads from internal business measurements and operations and outsourced partners and vendors. The second tier includes the collection of selected data elements into manageable groups or “Panels.” The third tier includes the graphical user interface that aggregates these information panels and displays the data to the loan specialist and assists him or her in making the loan acquisition decision.

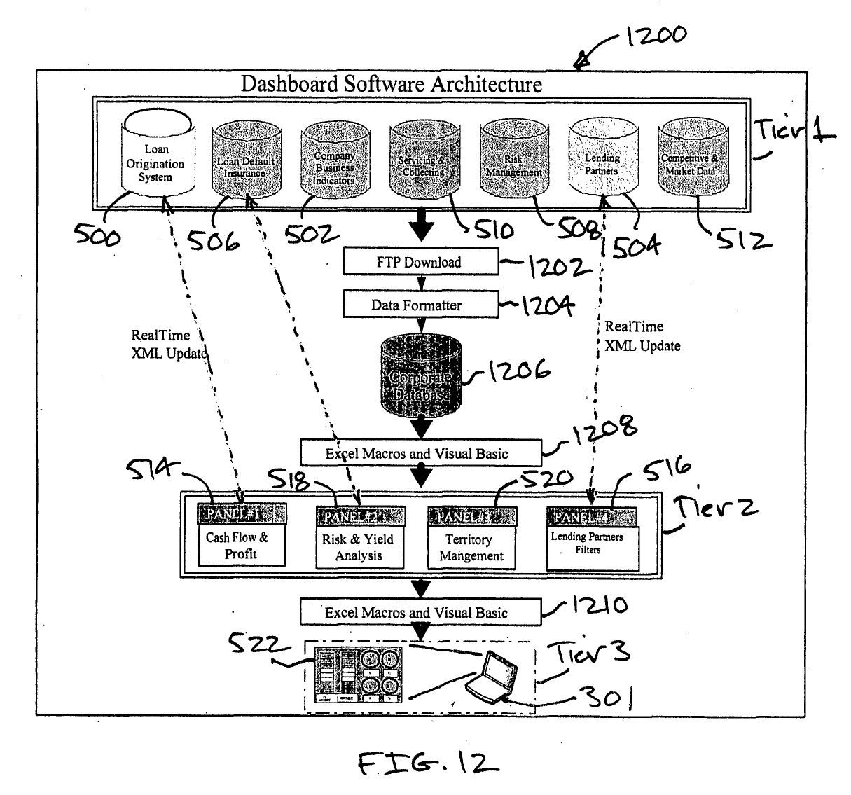

The following collection of data is downloaded periodically from internal company and outsourced partners and vendors. The collection of data is stored in a database (1206 in FIG. 12 to be discussed below) on the Lender's corporate server (308 in FIG. 3 discussed above). The data are sorted and sequenced in order to furnish the Lender with corporate management information as well as to upload to the senior loan specialist's laptop computer or alternative web access device to populate the memory of the Dashboard™ system.

Those of skill in the art will appreciate that database, as used herein, refers to a logical arrangement of data within a memory or storage device. There can be any number of databases on a physical disc drive or storage module, whether related to one another or not. Accordingly, references herein to particular databases illustrated as residing on physical storage modules or disc drives do not limit the location, partition or arrangement of data in memory. Broadly speaking, then, a database is very simply a collection of data.

Examples of the Data:

Corporate Information—Revenue, Profit, Cash Flow, Net Present Value, Return on Managed Assets (ROMA), Return on Investment (ROI), and Return on Equity (ROE) calculators, Senior Loan Specialist (SLS) feedback, SLS territory goal sheet and Lender's Financial Modeling (or that of an authorized user of the invented technology).

FIG. 6 is a screen grab of a territory management report 600 that is provided as a tool, in accordance with one embodiment of the invention, in loan purchase decision panel 514. The report includes a sub-region summary 602 near the top and, there under, component dealership summaries 604, 606, 608 that are summarized therein.

The sub-region summary 602 reports such stats as month-to-date (MTD) contracts and their received v. approved and income produced numbers data are tabulated. Budget v. Pace data in terms of dollar volume are tabulated. Budget v. Pace data in terms of number volume are tabulated. Sub-region MTD # volume data are tabulated, as are MTD actual figures data.

Particular dealer centers are represented in the territory management report by similar component summaries 604, 606, 608 for the entire territory and for each of a plurality of senior loan specialists (SLSs) or representatives (reps) within the center, in terms of MTD actual figures data. They also are represented therein by On Pace For . . . data that includes pending sales and that project # volume, $ volume and production fee $ for the current month. Those of skill in the art will appreciate that more or less or different data may be reported in quick stats report 600, suitably collated and presented to guide management in decision making.

FIG. 7 is a screen grab of a cash flow and loan profit calculator 700 that also is provided as a decision-making tool, in accordance with one embodiment of the invention, in loan purchase decision panel 514. Cash flow and loan profit calculator 700 in accordance with one embodiment of the invention includes an input table 702, a payment tab 704, a cash flow table 706 and a two-part calculation table 708. The user can enter particulars of a prospective deal into the right-side blue fields of input table 702 and the calculator automatically calculates and displays the remaining data including the monthly payment in payment tab 704 and the cash flow over the year and over the life of the deal in the cash flow table 706. Cost of funds, cumulative credit losses, cost to service, cost to originate, dealer participation (dealer part—the mark-up points on a dealer's sale of a loan contract to a lender having a lower APR) paid, taxes and other expenses are tabulated in the minus column 708a, along with a minus subtotal. Interest charge, ancillary, document (doc) fee and other income are tabulated in the plus column 708b underneath it, along with a plus subtotal. A user of cash flow and loan profit calculator 700 thus can instantly view the cash flow and loan profit that would result from a prospective deal. Those of skill in the art will appreciate that cash flow and loan profit calculator 700 can, within the spirit and scope of the invention, take alternative forms.

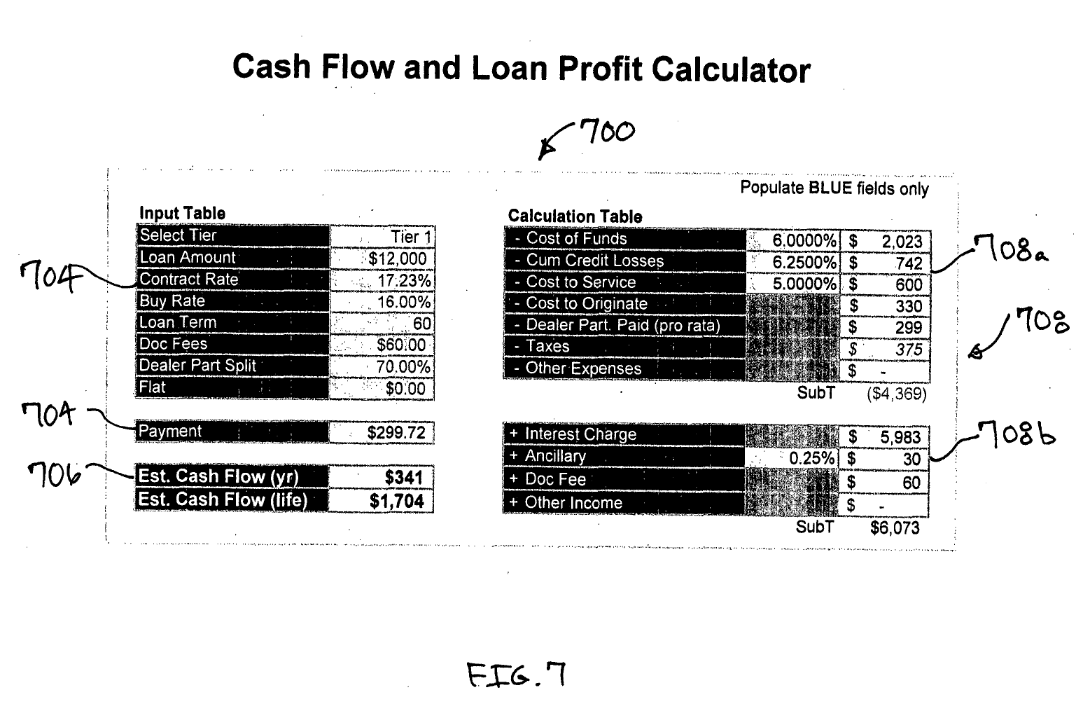

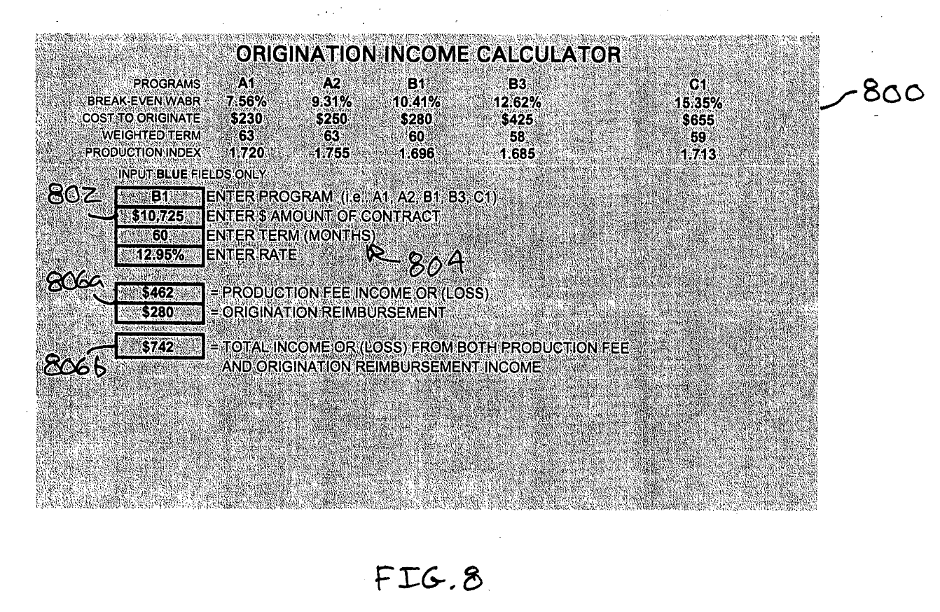

FIG. 8 is a screen grab of an origination income calculator 800 that also is provided as a tool, in accordance with one embodiment of the invention, in loan purchase decision panel 514. The highlighted boxes indicated generally at 802 with instructions generally indicated at 804 beside them can be filled in by a sales manager or SLS and the total production fee income or loss and origination free reimbursement results automatically calculated and presented at 806a. Similarly, total income or loss from the production fee and origination reimbursement fee data at 806a are automatically added together and the sum presented at 806b. Those of skill in the art will appreciate that the parameters of the calculations are sourced by, in accordance with one embodiment of the invention, and derive from loan origination system (LOS) 500. Those of skill also will appreciate that origination income calculator thus summarizes customer, collateral and deal structure information including rate, term, down payment, credit profile, and recommended loan program tier (based on credit score), e.g. B1. Alternative mechanisms and calculations are contemplated as being within the spirit and scope of the invention.

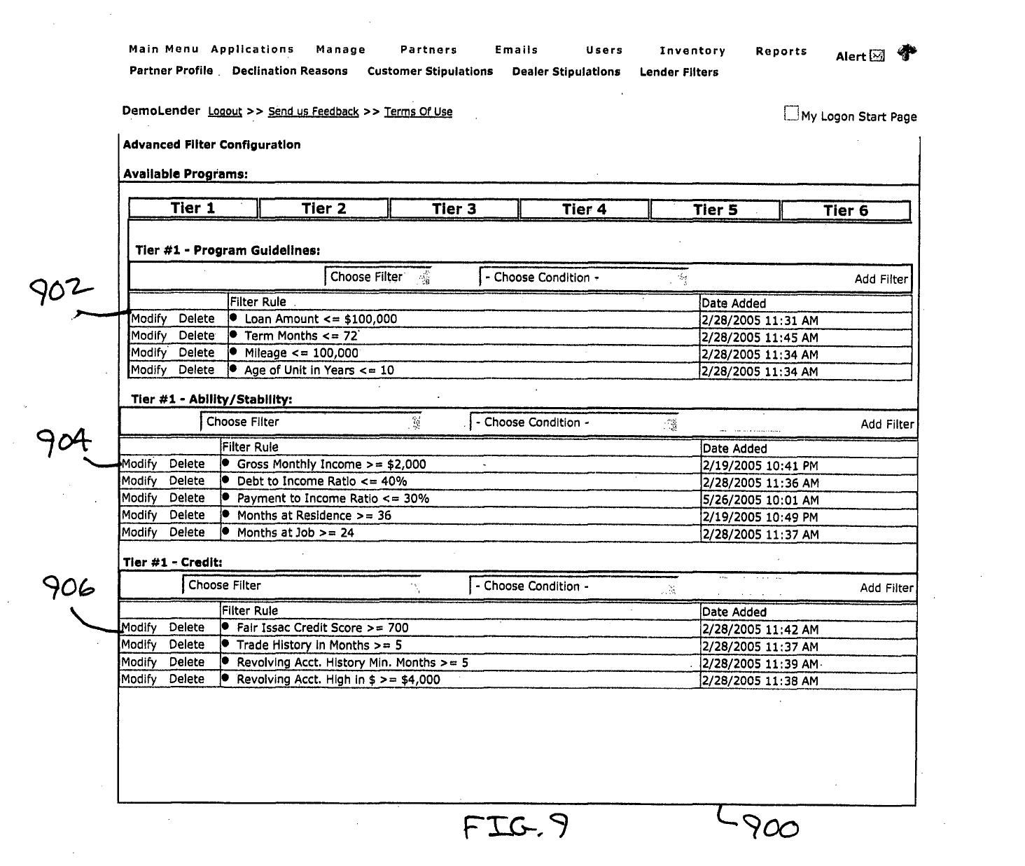

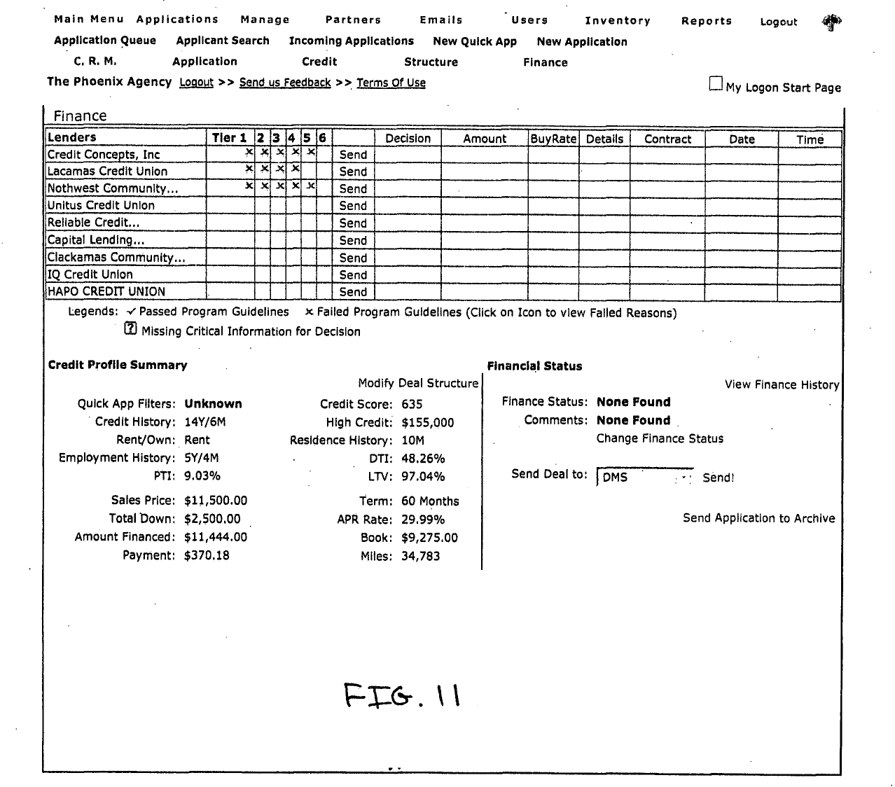

FIG. 9 is a screen grab representing a loan origination rules engine that interacts with the user and tabulates lender or underwriter program guidelines at 902, customer ability/stability at 904 and customer credit history at 906 for a given loan tier (1-8). (Those of skill in the art will appreciate that loan tiers, which represent a customer's credit score, should not be confused with Dashboard™ system architecture tiers 1, 2 and 3 described above.) Engine 900 will be understood to involve a choice of filters and conditions that are available in drop-down menus. The rules enforced by engine 900 can be deleted or modified, as suggested, and their addition/modification dates can be logged. Those of skill in the art will appreciate that data representing a prospective deal can be run through engine 900 to evaluate whether a particular deal is likely to succeed with any lender, i.e. engine 900 is not lender-specific. (Lender-specific filters will be discussed below by reference to FIG. 11.) Those of skill in the art will appreciate that alternative capabilities, menus, options, choices and arrangements of loan origination rules engine 900 are contemplated as being within the spirit and scope of the engine. Those of skill will also appreciate that, typically, the rules engine that generates a consumer's custom scorecard resides inside the loan origination system (LOS).

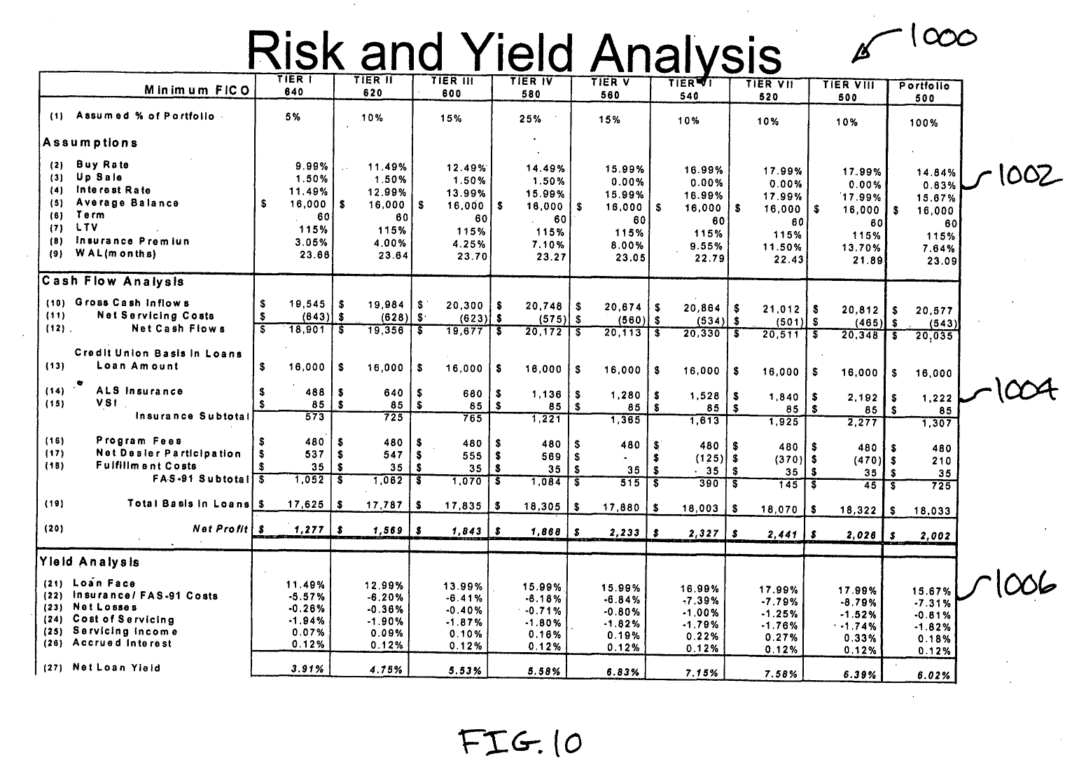

FIG. 10 is a screen grab representing a risk and yield analysis 1000 that also is provided as a tool, in accordance with one embodiment of the invention, in risk management panel 518. Servicing and collection data 510 input to risk management panel 518 include, for example, delinquencies, 30, 60, 90 days, charge-offs, repossessions (repos), etc. Loan default insurance data 506 and risk management data 508—including, for example, frequency, severity, weighted average life of loan, prepayment frequency, default frequency, loss curves, etc. typically provided by third parties—are analyzed in accordance with underwriter guidelines to assess the risk and yield data regarding a prospective deal. The risk and yield data are tabulated and presented to the user in tabular sections including an assumptions table 1002, a cash flow analysis table 1004 and a yield analysis table 1006. Those of skill in the art will appreciate that more or less or different data can, within the spirit and scope of the invention, be gathered, processed, analyzed and tabulated.

Those skilled in the art will appreciate that, if in its interest, Lender secures the loan contract for its own portfolio, based upon the risk, cash flow, profit, income, mix or other business performance criteria established by Lender's owners or managers. There are times, however, when a given loan contract does not ‘fit’ in the Lender's portfolio. For example, a Lender may not offer extended-term financing, but it has an affiliated Lending Partner that does. In such a case a Lender might broker the extended-term loan contract for a fee to one of its Lending Partners. This alternative to holding a given loan contract is facilitated by the invention, as described below.

FIG. 11 is a screen grab of a lending partner filters panel 1100 representing the results of analyzing a prospective deal by running it through a set of lending partners filters and tabulating the results, a feature provided by lender management panel 516. Particular lending partners' underwriting guidelines, loan pool information, purchaser coupon, loss reserve and other data are used to analyze a prospective deal, and the user viewing panel 1100 very straightforwardly can determine from the presence of a check-mark (✓) or a cross-out (X) whether a particular lending partner would buy the paper from such a loan deal. Those of skill in the art will appreciate that this analysis involves the use of competitive information, which may include results of periodic surveys of lenders in the market and the use of current rate-sheets detailing their lending programs. Besides tabulating the multi-tiered filter results by lender, panel 1100 also provides a credit profile summary and a financial status summary. Other features of panel 1100 permit the SLS to modify the deal structure and run it through the filters again, and/or to view the finance history of the customer or client. Those of skill in the art will appreciate that more or less or different filters or lenders or tabulations or presentations are contemplated as being within the spirit and scope of the invention.

In brief summary, data are downloaded from the corporate and third-party databases and are consolidated, organized and summarized into meaningful groups or “Panels” that are generated by one or more data processing engines. These “panels” allow the SLS to view the data in a meaningful way. What's the cash flow on this loan I am looking to purchase? If the cash flow is not adequate, what terms do I need to make it a profitable loan for my company? Do I need to increase the interest rate? The loan acquisition fee? The term of the loan?

These panels can be viewed and used for decision-making by the senior loan specialist (SLS), but the ultimate intent is for these data to be mapped into a GUI (Graphical User Interface)—The Sequoia™ Dashboard™ and to give the SLS a computer-generated iconographic assessment. The iconographic representation allows the SLS to make the loan decision faster. The SLS can always revert back to the “Panels” detailed information, if needed, to further analyze the automated iconographic assessment by looking at the underlying data.

Thus, the Sequoia™ Dashboard™ windows/screens are displayed as a graphical user interface (GUI). The data that have been consolidated into “Panels” are further consolidated in the graphical interface. This is the culmination of the loan decision process. The data field inputs indicate risk and profit tolerances based on user-supplied data input (rate, term, fee & LTV) with individual loan characteristics from loan information panes and underwriting, portfolio performance and servicing/collection information from risk management panel 518 running in the background, supplying real-time analytical tools and information flow. How the Sequoia™ Dashboard™ software system 200 works will be discussed next.

FIG. 12 is a schematic block diagram that illustrates the functional blocks, i.e. the architecture, of the Sequoia™ Dashboard™ software system 200. Remote Tier 1 databases in the form of disc drives or servers include loan origination system (LOS) data 500, company business indicators data 502, lending partners data 504, loan default insurance data 506, risk management data 508, servicing & collection data 510 and competitive info from lenders 512 are as described above. Data from these Tier 1 databases are downloaded at 1202 using a standard file transfer protocol (FTP) or other suitable means to a data formatter 1204. It will be understood that such data downloads can be accomplished via batch downloads that are periodic or via more frequent supply/demand-based updates, whether based upon either demand from data formatter 1204 or a prompt from the database the data of which have changed. Data formatter 1204 is a straightforward software routine that formats the various 3-P data files into a form compatible for storage on a corporate (user) database 1206 that resides either on a local company server or a remote web-based server. Those of skill in the art will appreciate that the panels shown in FIG. 12 correspond to panels 514, 516, 518, 520 of FIG. 5 and represent the data processing and formatting for presentation in a legible and useful form, e.g. a spreadsheet. Thus, an Excel™ macro and Visual Basic block 1208 straightforwardly builds the panels of Tier 2 of the Sequoia™ Dashboard™ system architecture.

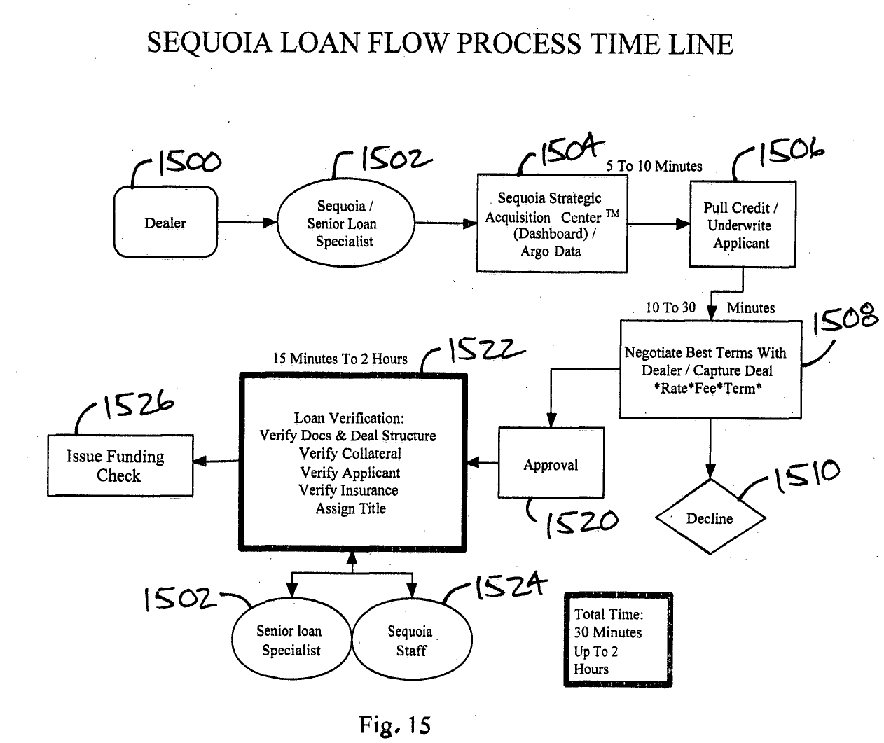

Tier 2 panels include loan purchase decision panel 514, lender management panel 516, risk management panel 518 and marketing & production panel 520 described in detail above. These panels, as described and illustrated herein, represent processed data including company data such as cash flow, profit and yield goals; 3-P data such as customer credit history, underwriting and lender guidelines or filters; and recent customer employment and income history acquired ‘live’ (i.e. proximate, face-to-face or at least in real time, e.g. over the phone) from a customer or client. The panels take various useful forms, whether tabulated histories and projections or calculators or sets of filter rules for various lenders. The SLS uses the panels to make lending decisions in real time with a live customer in a matter of moments, as will be seen by reference to FIG. 15.

These real-time decisions are possible by virtue of the real-time, web-based architecture of Sequoia™ Dashboard™ system 200. For example, the inputs to panel 514 can be continuously updated in real time by an XML routine ensuring the panel utilizes the latest data from LOS database 500. Similarly, the inputs to panel 518 can be continuously updated in real time by a similar XML routine ensuring the panel utilizes the latest data from loan default insurance database 506. Similarly, the inputs to lender management panel 516 can be continuously updated in real time by a similar XML routine ensuring the panel utilizes the latest data from lending partners database 504. Since all data within the various databases, including 3-P and corporate databases, are subject to change, the real-time XML updates keep the panels current so that smart, quick and sure lending decisions can be made.

Another set of Excel™ macros and visual basic routines at 1210 generate iconographic work panel 522, further facilitating decision making at Tier 3. It will be understood that raw and processed data panels 514, 516, 518, 520 as well as iconographic work panel 522 are viewable on a display screen of laptop computer 301, PDA, mobile phone or other web access device providing simple display and input functionality (see FIG. 5). Such a portable battery-operated device capable of basic key entry, display and electronic communication can even offer portable, battery-operated print functions for transaction-sited check printing if needed. Any and all such devices are contemplated as being capable of running the Sequoia™ Dashboard™ system software and enabling smart, real-time business decision making, deal closing and fulfillment. The software can execute on a 3-P application service provider's (ASP's) server that is remote from the user and that is accessed via a wide-area network (WAN) such as the world-wide web, i.e. the Internet, and can affect the portable device's display and input functions. Alternatively, and still within the spirit and scope of the invention, the invented system software can be stored in memory, e.g. random access memory (RAM) or read-only memory (ROM) or suitable a FLASH or so-called ‘stick’ memory and execute in a processor, e.g. a microprocessor, embedded within the portable device itself.

Tables 1, 2, 3 and 4 immediately below respectively tabulate the data structures used in connection with Loan Income Calculator Input, Efficiency Input, Loan Origination System (LOS) Input and Risk and Yield Analysis. Each table illustrates the name of each field of data, its type, its size and its contents. Those of skill in the art will appreciate that the data structures actually used in conjunction with the invention can, within the spirit and scope of the invention, have other contents and/or take other forms.

TABLE 1
Loan Income Calculator Input
Loan Income Calculator Input

| Field Name | Type | Size | Contents |
|---|---|---|---|
| Buy Rate | Number | 6 | Interest Rate of the loan |
| | | | bought from the Dealer |
| Dealer Participation | Number | 5 | Interest Fee too the Dealer |
| Contract Rate | Number | 6 | Face Value Interest Rate |
| Average Balance | Number | 7 | Average amount of the loan |
| Term | Number | 2 | Term of the Loan |
| Loan to Value | Number | 6 | Amount of the loan over |
| | | | the value of the vehicle |
| Weighted Average Life | Number | 8 | Average Life of the loan |
| Gross Cash Flows | Number | 7 | Cash flow over the life |
| | | | of the loan |
| Net Servicing Cost | Number | 6 | Cost to service the loan |
| | | | over the life of the loan |
| Origination Fee | Number | 5 | Internal Cost to Originate |
| | | | a loan |
| Net Cash Flow | Number | 7 | Cash Flow less Servicing |

TABLE 2
Efficiency Input
EFFICIENCY Input

| Field Name | Type | Size | Contents |
|---|---|---|---|
| Applications | Number | 8 | Total Applications Received |
| Approved | Number | 8 | Total Applications Approved |
| Conditioned | Number | 8 | Applications with Conditions |
| Declined | Number | 8 | Total Applications Declined |
| Funded | Number | 8 | Total Applications Funded |
| Approval Ratio | Number | 8 | Approvals over Total |
| | | | Applications |
| Capture Ratio | Number | 8 | # of Funded over |
| | | | Approvals |
| Conversion % | Number | 8 | # of Funded over |
| | | | Applications |
| Conversion | Number | 8 | # of Application to |
| Ratio (LTB) | | | Convert to Funded |

TABLE 3
Loan Origination System (LOS) Input
Loan Origination System Input

| Field Name | Type | Size | Contents |
|---|---|---|---|
| Loan Amount | Number | 10 | Amount Financed |
| Loan Term | Number | 2 | Term in Months |
| Contract Interest Rate | Number | 5 | Face Value Interest |
| | | | Rate |
| But Interest Rate | Number | 5 | Effective Yield |
| Mileage | Number | 8 | Vehicle Mileage |
| Vehicle Year | Number | 4 | Year Made |
| Loan To Value | Number | 5 | Amount Financed over |
| | | | Book Value of the Car |
| | | | (%) |
| Gross Monthly Income | Number | 8 | All Income incl. |
| | | | Wages, etc. |
| Debt to Income Ratio | Number | 4 | Total Debt over Total |
| | | | Income |
| Payment to Income Ratio | Number | 4 | Total Payment over |
| | | | Total Income |
| Months at Residence | Number | 2 | Total Months at Current |
| | | | Residence |
| Months at Current Job | Number | 2 | Total Months at Current |
| | | | Job |
| Months at Prior Job | Number | 2 | Total Months at Prior |
| | | | Job |
| Fico Score | Number | 3 | Fair Isaac Credit Score |
| Revolving Acct. History | Number | 5 | Credit History in Months |
| Revolving Acct. High in $ | Number | 5 | Total Revolving Debt |
| Book Value | Number | 7 | Kelly Blue Book |
| | | | Wholesale Value |

TABLE 4
Risk and Yield Analysis
Risk and Yield Analysis

| Field Name | Type | Size | Contents |
|---|---|---|---|
| Buy Rate | Number | 6 | Interest Rate of the loan |
| | | | bought from the Dealer |
| Dealer Participation | Number | 5 | Interest Fee too the Dealer |
| Contract Rate | Number | 6 | Face Value Interest Rate |
| Average Balance | Number | 7 | Average amount of the loan |
| Terra | Number | 2 | Term of the Loan |
| Loan to Value | Number | 6 | Amount of the loan over |
| | | | the value of the vehicle |
| Insurance Premium (%) | Number | 6 | Cost of the Default |
| | | | Insurance as a % of the loan |
| Weighted Average Life | Number | 8 | Average Life of the loan |
| Gross Cash Flows | Number | 7 | Cash flow over the life |
| | | | of the loan |
| Net Servicing Cost | Number | 6 | Cost to service the loan |
| | | | over the life of the loan |
| Net Cash Flow | Number | 7 | Cash Flow less Servicing |
| Insurance Premium ($$$) | Number | 4 | Cost of Insurance in $$$ |
| VSI | Number | 4 | Insurance to cover |
| | | | vehicle loss |
| Program Fees | Number | 2 | Fee paid to Insurance |
| | | | Administrator |
| Net Dealer Participation | Number | 4 | Dealer Participation less |
| | | | Acquisition Fees |
| Fulfillment Cost | Number | 4 | Cost to Originate a loan |
| FAS-91 Costs | Number | 5 | Total Costs associated |
| | | | with Insurance |
| Insurance Costs in Yield | Number | 5 | Insurance Costs as a % |
| Net Losses as Yield | Number | 5 | Net Losses as a % |
| Cost of Servicing Yield | Number | 5 | Cost of Servicing as a % |
| Servicing Income Yield | Number | 5 | Servicing Income as a % |
| Accrued Interest Yield | Number | 5 | Accrued Interest as a % |
| Net Loan Yield | Number | 5 | Net Loan Yield as a % |

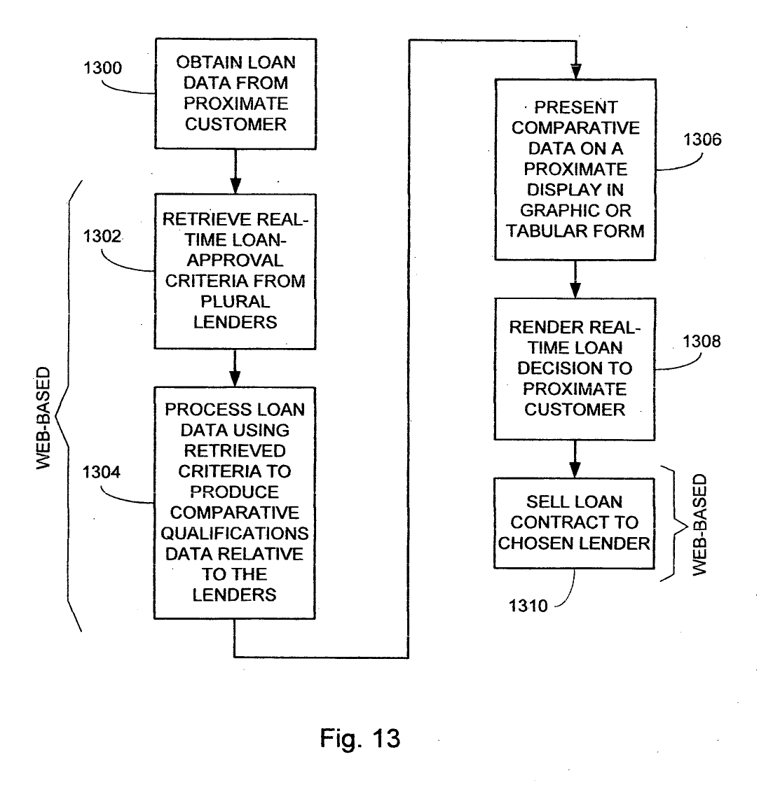

FIG. 13 is a flowchart illustrating a real-time computer-assisted loan decision-making method in accordance with one embodiment of the invention. The method includes at 1300 obtaining loan application data from a proximate customer; at 1302 retrieving real-time loan-approval criteria via a remote data source from plural lenders or underwriters; at 1304 processing the loan application data on a computer using the retrieved criteria to produce comparative data regarding loan qualifications of the proximate customer relative to the plural lenders or underwriters; and at 1306 presenting the comparative data on a proximate display in graphical or tabular form. The method preferably further comprises at 1408 rendering a real-time loan decision to the proximate customer. The method also preferably further comprises at 1310 brokering or even selling a contract representing the loan to the chosen lender or underwriter.

Most preferably, the method culminates in fulfillment for the consumer, e.g. the consumer drives away a new car, as well as fulfillment for the dealership and its salesperson, e.g. a check is cut or and ACH transaction is processed so that the dealership gets its money and the salesperson gets his or her commission.

All in a matter of moments.

And with no “buyer's remorse” for the Lender or Lending Partner.

Thus, those of skill in the art will appreciate that method steps 1302, 1304 and 1310 preferably are web-based, i.e. they are done using the Internet as described and illustrated above in accordance with the invention. Those of skill in the art also will appreciate that the presentation on a proximate display of the comparative data in graphical or tabular form is performed in accordance with the invention preferably with a laptop computer display screen displaying one or more of Dashboard™ tabular panels 514, 516, 518, 520 and graphical panel 522 as described above by reference to FIG. 5.

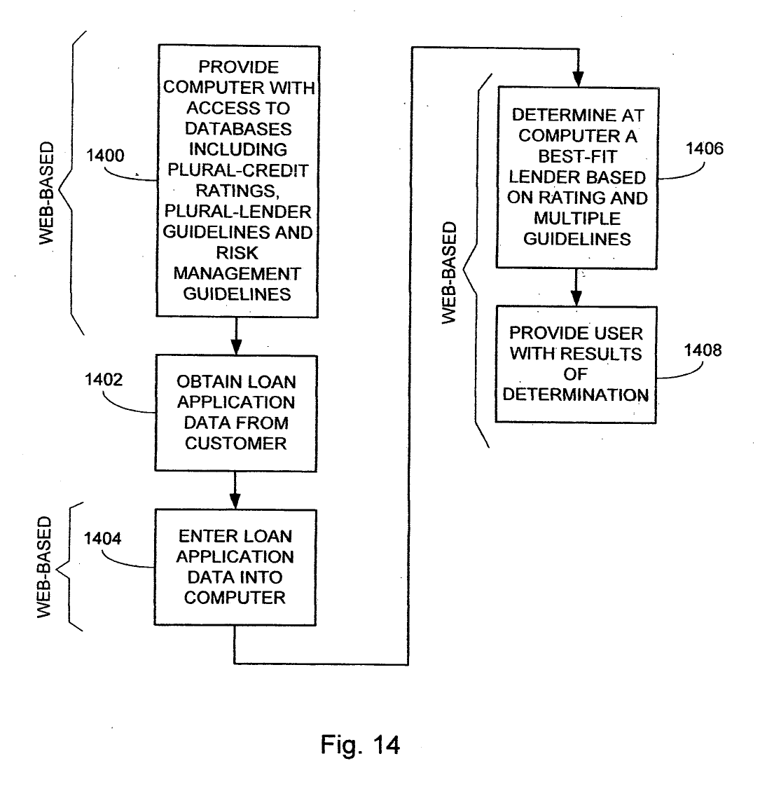

FIG. 14 is a flowchart illustrating a web-based financed-sale management method including at 1400 providing a computer with access to databases including plural-credit ratings, plural-lender guidelines and user, e.g. retailer, risk management guidelines; at 1402 obtaining loan application data from a customer; at 1404 entering the loan application data into the computer; at 1406 determining at the computer a best-fit lender based on the credit rating data for the particular customer and based also on the plural-lender guidelines and the risk management guidelines; and at 1408 providing the user, e.g. the retailer, with the results of the determination. As discussed above, the user within the spirit and scope of the invention can be provided the results in the form of tabulated data in a display window or in the form of an iconographic indication, e.g. one or more loan merit-level gauges that are multi-segmented and color-coded, as described and illustrated herein.

FIG. 15 shows the timeline for loan approval made possible by use of the invention. Using the Sequoia™ Dashboard™ system, a dealer 1500 gives a file representing a prospective deal to an SLS 1502 who at 1504 enters the required Sequoia™ Dashboard™ data into his or her laptop computer 301. This now takes only five to ten minutes. Next, the SLS at 1506 pulls the prospective customer's credit and underwriter guidelines from the various sources described above and reviews one or more panels 514, 516, 518, 520 and/or work panel 522. This now takes only ten to thirty minutes. At 1508, the SLS negotiates best terms with the dealer and captures the deal by finding an optimum rate/fee/term, much facilitated by the use of the invented software and presentation panels. The customer's application is instantly declined at 1510 or approved at 1512, by virtue of the LOS, guideline, lender filter, credit history and myriad other databases accessed by the invented system. Upon approval, verification at 1522 involving SLS 1502 and perhaps other company staff 1524 is completed in only fifteen minutes to 2 hours. Moments later, at 1526, the deal is funded and a check is issued (if deemed secure enough a procedure) or an equivalent automatic clearing house (ACH) transaction is processed.

Total time to process a workable deal using the invented system is reduced to as little as thirty minutes and no more than three hours. Moreover, as pointed out above, the deal is more certain for the customer, more profitable for the Lender and more acceptable to the Dealership, since its terms and conditions already have been determined based upon data-based rules, filters and guidelines; broad but pertinent data gathering, processing, tabulating, calculating and presenting; and decisional facilities such as tabular and/or iconographic panels.

It will be understood that the present invention is not limited to the method or detail of construction, fabrication, material, application or use described and illustrated herein. Indeed, any suitable variation of fabrication, use, or application is contemplated as an alternative embodiment, and thus is within the spirit and scope, of the invention.

From the foregoing, those of skill in the art will appreciate that several advantages of the present invention include the following.

The present invention provides many advantages over conventional loan or business management decision-making systems and methods. Multiple databases are made available to the system software for processing, analyzing and reporting, e.g. presenting, to a decision maker, e.g. an SLS, to make the decision-making process comprehensive of a broad range of decisional parameters. The databases and the application software preferably reside on plural remote third-party (3P) servers and thus unburden the user of capital cost. The software is very user-friendly, and presents its analysis and tabulated or graphic results in easy-to-read panels, at least one of which preferably is interpretive and easily read, e.g. iconographic. The system effectively qualifies a prospective customer for a loan deal by effectively filtering out unqualified customers from any lender and/or by effectively filtering out lenders whose guidelines the customer cannot meet and re-routing a loan application to another lender which has less stringent guidelines.

The invented system takes into account the profitability and other business goals of the Lender by factoring into the semi-automatic analysis and decision-making process not only a customer's credit history, employment information, etc. and not only the lender's or underwriter's filters or guidelines or other standards, but also the Lender's cash flow, profit goals and risk management guidelines. Thus, the system assists a sales person, sales manager, division manager or owner to make decisions that are self-interested and that ensure that business goals are met in the short and longer term. The system speeds up the process by operating in real time with up-to-date screening and qualification parameters that are subject to change and that are controlled by third parties. The system increases the efficiency of the loan decision-making process by avoiding a large fraction, i.e. nearly half, of the usual waste of time that a lender spends reviewing and disqualifying, i.e. declining to approve or purchase, 90% of the loan applications it receives.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

Finally, those of skill in the art will appreciate that the invented method, system and apparatus described and illustrated herein may be implemented in software, firmware or hardware, or any suitable combination thereof. Preferably, the method system and apparatus are implemented in a combination of the three, for purposes of low cost and flexibility. Thus, those of skill in the art will appreciate that the method, system and apparatus of the invention may be implemented by a computer or microprocessor process in which instructions are executed, the instructions being stored for execution on a computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims.

1. A real-time computer-assisted loan decision-making method comprising:
obtaining loan application data from a proximate consumer;
retrieving real-time loan-approval criteria via a remote data source from plural lenders or underwriters;
processing the loan application data on a computer using the retrieved criteria to produce comparative data regarding loan qualifications of the proximate customer relative to the plural lenders or underwriters; and
presenting the comparative data on a proximate display in graphical or tabular form.

2. The method of claim 1, wherein the criteria-retrieving is web-based.

3. The method of claim 2, wherein the processing is web-based.

4. The method of claim 3 which further comprises:
rendering a real-time loan decision to the proximate customer.

5. The method of claim 4 which further comprises:
selling or brokering a contract representing the loan to a chosen one of the plural lenders or underwriters.

6. The method of claim 5, wherein the selling is web-based.

7. A distributed, real-time loan decision-making system comprising:
an application service provider (ASP) including a server at a location remote from a retailer location;
plural databases accessible via a network by the ASP, the databases including at least customer credit data and underwriter parameter data; and
data processing software configured to execute on the ASP and to process the data from the plural databases and to generate decision panels based thereon for viewing and loan decision-making by the user on a device at the retail location that includes a display.

8. The system of claim 7, wherein the data in the databases are substantially continuously maintained by plural providers thereof.

9. The system of claim 7, wherein the device at the retail location is portable and capable of data entry and network access by the user.

10. The system of claim 9, wherein at least one of the decisional panels is an iconographic work panel that includes an array of indicators of loan parameters that are changeable by the user by data entry thereto.

11. The system of claim 9, wherein the data processing software automatically formulates a measure of the degree of conformity of the customer credit data to the underwriter parameter data, and wherein the iconographic work panel further includes one or more bar graphs representing the degree of conformity therebetween.

12. The system of claim 7, wherein the databases further includes retailer fiscal parameters, and wherein the data processing software generates decisional panels based also thereon.

13. The system of claim 12, wherein the data processing software automatically formulates a measure of the degree of conformity of the customer credit data and the underwriter parameter data to the retailer fiscal parameters, and wherein the iconographic work panel further includes one or more bar graphs representing the degree of conformity therebetween.

14. The system of claim 13, wherein the retailer fiscal parameters include two or more of a cash flow, a profit goal and a risk management parameter.

15. A web-based financed-sale management method comprising:
providing a computer with world-wide web access to databases including plural-customer credit ratings, plural-lender guidelines and user risk management guideline data;
obtaining loan application data from a live customer;
entering the loan application data into the computer over the world-wide web; and
determining at the computer a best-fit lender based on accessed live customer credit rating data, plural-lender guidelines and risk management guideline data.

16. The method of claim 15 which, before the informing step, further comprises:
providing a user with the results of the determining step.

17. The method of claim 16, wherein the providing includes presenting on a display tabulated data upon which the determining is based.

18. The method of claim 17, wherein the providing further includes presenting on a display an iconographic indication of the results of the determining step.

19. The method of claim 18, wherein the further providing is of a loan merit-level gauge that is multi-segmented and color-coded.

20. A portable loan-based sales management decision-making and fulfillment system comprising:
prospective deal data specific to a prospective customer and a prospective loan-based sale of goods or services, the deal data residing in a first web-accessible database;
plural web-accessible second databases containing at least plural-consumer credit rating data and plural-lender or plural-underwriter guideline data;
a web-based application service provider (ASP) having access to the first and second databases, the ASP executing decision-making software capable of processing the plural-lender data or plural-underwriter guideline data and the prospective deal data and storing the processed data in a screening results database; and
a web access device remote from the ASP and capable of downloading the processed data from the screening results database and presenting the processed data on a display for prospective deal decision-making by a decision-maker.

21. The system of claim 20 which further comprises:
decision-maker risk-management guideline data residing on a third web-accessible database,
wherein the ASP having access also to the third database is also capable of processing the risk management guideline data and storing the processed data in the screening results database.

22. The system of claim 21 which further comprises:
decision-maker cash flow data residing on a fourth web-accessible database,
wherein the ASP having access also to the fourth database is also capable of processing the cash flow data and storing the processed data comprehensive of all accessible databases in the screening results database.

23. The system of claim 22 which further comprises:
decision-maker profit goal data residing on a fifth web-accessible database,
wherein the ASP having access also to the fifth database is also capable of processing the profit goal data and storing the processed data comprehensive of all accessible databases in the screening results database.

24. The system of claim 23, wherein the access device is portable and presents the results in at least one of tabular and graphical form.

25. The system of claim 24, wherein the access device includes a loan decision-facilitating tool providing an interactive, iconographic display window displaying a set of loan parameters and a set of prospective lenders or underwriters, the elements of at least one of the sets being adjustable by the decision-maker to determine a suitable lender or underwriter and suitable parameters that are compatible therewith.

26. A loan decision-facilitating computer software tool comprising:
an iconographic display window associated with a computer, the window displaying a set of plural loan parameters, at least one of the parameters within the window being adjustable by user input;
a first computer software mechanism responsive to user input on the at least one parameter, the mechanism calculating any changes to other of the plural loan parameters and updating the display window to reflect such any changes;
a second computer software mechanism for analyzing the plural loan parameters within the display window and assigning a merit level to the loan represented by the plural loan parameters based upon defined merit criteria stored in the computer; and
a graphic gauge in the display window coupled with the second computer software mechanism for indicating to the user the assigned merit level.

27. The software tool of claim 26 wherein the plural loan parameters include two or more of interest rate, amount, term and loan-to-value.

28. The software tool of claim 27, wherein the graphic gauge includes a segmented and color-coded bar graph the position of a highlighted segment of which indicates relative merit level.
